(19) United States
(12) Patent Application Publication
(10) Pub. No.: US 2008/0227766 A1
(43) Pub. Date: Sep. 18, 2008

(54) Synergistic, Silver-Containing Biocide Composition

(75) Inventors: Thomas Wunder, Neustadt (DE); Roman Grabbe, Neustadt (DE); Rudiger Baum, Waghausel (DE)

Correspondence Address: NIXON PEABODY, LLP, 401 9TH STREET, NW, SUITE 900, WASHINGTON, DC, 20004-2128, US

(73) Assignee: THOR GMBH, Speyer (DE)

(21) Appl. No.: 12/065,401

(22) PCT Filed: Aug. 31, 2006
(86) PCT No.: PCT/EP06/65878

§ 371 Date: Apr. 8, 2008

(30) Foreign Application Priority Data
Sep. 2, 2005 (DE) 10 2005 042 023.0
May 18, 2006 (DE) 10 2006 023 481.2

(51) Int. Cl. A01N 55/02; A01P 15/00

(52) U.S. Cl. 514/186

(57) ABSTRACT

A biocidal composition comprising a combination of at least two biocidal components, in which 1,2-benzisothiazolin-3-one and/or N-methyl-1,2-benzisothiazolin-3-one and/or N-methyl-1,2-benzisothiazolin-3-one are used as one component and silver in the form of, for example, organic or inorganic silver salts, colloidal or nanoparticulate silver or silver oxide is used as the other component, has a broad spectrum of activity against diverse bacteria and fingi.

The invention relates to a biocidal composition which comprises a combination of at least two biocidal components. One component in this combination is a specific isothiazolinone component and the other component is silver. This biocidal composition can be used to control harmful microorganisms.

Biocidal products are used in numerous areas of everyday life, as for example for the control of harmful bacteria, fingi or algae. It has long been known to use compounds from the class of the 3-isothiazolin-3-ones (which are also referred to as 3-isothiazolones) in compositions of this kind.

This class of compound includes very effective biocidal compounds with in some cases different activity profiles. Use is also often made of combinations of different 3-isothiazolin-3-ones with other known biocidal actives (see, for example, WO 99/08530 A, EP 0457435 A, EP 0542721 A, and WO 02/17716 A).

In light of the continually growing requirements imposed on biocide compositions, with respect, for example, to considerations of health and environmental protection, the further development of these known products is necessary.

For centuries it has been known that silver and its compounds may have a germicidal or antimicrobial activity. For a variety of reasons, the use of silver compounds as antimicrobial agents is restricted to particular fields.

Silver preparations which have been described for use in preservation include, for example, elemental silver in colloidal form, dispersions of nanoparticulate silver, silver compounds such as silver oxide or organic and inorganic silver salts. The silver or the silver compounds in these preparations may also be imbedded in carrier materials, such as silicas, titanium dioxide, zeolites or glass, for example.

One of the drawbacks of silver-mediated preservation is that silver compounds, more particularly in the presence of reducing compounds and under the influence of light, can lead to instances of unwanted discoloration. Furthermore, the activity of silver with respect to yeasts and molds is not as pronounced as it is with respect to bacteria, hence necessitating higher concentrations for a balanced spectrum of activity. This increases the risk of discoloration. Moreover, as compared with many other biocidal formulations on the market, silver-containing biocide preparations are also fairly expensive, which significantly limits their use.

Examples of common fields of use of silver as an antimicrobial agent encompass the sectors of medicine and of pharmacy and also of water treatment. In the sector of industrial preservation, in the case of adhesives, sealants, and coating materials, for example, such as paints, plasters and varnishes; in the case of bath and WC articles; and also in the case of polymer dispersions, pigment preparations, and plastics, silver is known. German patent application DE-A 10346387 identifies silver as a possible preservative.

Back in 1984, Patent Abstract of Japan 59-142543 described the use of antiseptic isothiazolinones in photographic material also containing silver chloride. WO 02/15693 refers very generally to the use of metallic zeolites (including, for example, those containing silver) in biocide mixtures.

The patent GB 1 389 940 discloses solutions of isothiazolinones protected from decomposition with a salt of a metal, and also paint materials comprising this composition. The metal may be silver.

JP-A 08092010 discloses an antimicrobial resin composition which comprises a small amount of an isothiazolinone and of an antimicrobial metal or a metal compound. The metal may be silver.

JP 2000044415 discloses an inorganic laminar compound which comprises a silver complex and an antimicrobial compound. The antimicrobial compound is preferably an isothiazolinone. The inorganic laminar compound is preferably calcium phosphate.

DE-A 43 39 248 discloses storage-stable aqueous solutions of isothiazolinones which comprise a noble metal ion in a specific amount. The noble metal ion may be silver. The only isothiazolinones named are MIT and CIT.

It is an object of the present invention to provide a new biocidal composition comprising at least two biocidal components, which is distinguished in that its components advantageously supplement one another or cooperate synergistically and therefore can be used at lower concentrations as compared with the concentrations needed in the case of the individual components. A further object is to use the abovementioned biocidal components for coatings (such as varnishes or paints, for example). Finally, a further object is to produce products which have been rendered biocidal, the products more particularly being coating and paint materials.

The intention, then, is to reduce the burden on humankind and the environment and also to lower the costs of controlling harmful microorganisms.

This object is achieved in accordance with the invention by the biocidal composition comprising a combination of at least two biocidal components, one component comprising at least one compound from the group containing 1,2-benzisothiazolin-3-one, N-methyl-1,2-benzisothiazolin-3-one, and N-butyl-1,2-benzisothiazolin-3-one, and also comprising silver as a further biocidal component.

The biocide composition of the invention is distinguished by the synergistic cooperation of the benzisothiazolinone (benzisothiazolinone component) with the silver, thereby making it possible to lower the required use concentrations of the benzisothiazolinone or of the benzisothiazolinone component and/or of the silver. As a result of this it is possible in numerous fields of application to lower the sensitizing effect of biocide compositions comprising benzisothiazolinones, and to improve their environmental compatibility. At the same time it is possible to lower the costs as compared with known silver-containing biocide preparations. A further advantage of the biocide composition of the invention, in addition to its broad activity spectrum, lies in its long-term stability and long-term activity.

The biocide compositions of the invention and the products and preparations rendered antimicrobial using them are storage-stable and, on account of the lower levels of silver, exhibit significantly lower discoloration tendencies than the known silver-containing products. The preparation can easily be formulated so that there are no instances, or at least no notable instances, of discoloration or graying of the products rendered biocidal in accordance with the invention when they are properly employed. Thus the biocide composition of the invention is suitable more particularly for the biocidal treatment of products for which it is desired that there be no discoloration or graying in practical use, such as for paints, adhesives, dispersions, latices, varnishes, and the like, for example.

A further advantage of the biocide compositions of the invention is that they have low emissions, more particularly in comparison to biocide compositions based solely on 3-isothiazolin-3-ones. For this reason as well they are particularly suitable for in-can preservation and film preservation (see also paints, varnishes, adhesives and the like). Furthermore, with the absence of halogenated 3-isothiazolin-3-ones, more particularly with the absence of 5-chloro-2-methylisothiazolin-3-one, the biocide composition of the invention can advantageously be formulated in such a way that it falls well below the AOX levels that are prescribed by statute in Germany. And the toxicological and ecotoxicological characteristics of the biocidal composition of the invention are improved.

Benzisothiazolinone contemplated comprises the three abovementioned compounds 1,2-benzisothiazolin-3-one, N-methyl-1,2-benzisothiazolin-3-one, and N-butyl-1,2-benzisothiazolin-3-one, whereas other 3-isothiazolinones that are known for biocide compositions have been found less suitable: see, for example, chloromethylisothiazolinone.

The biocide composition of the invention may comprise as one component only one or else a mixture of two of the abovementioned benzisothiazolin-3-ones. In this context, in one embodiment, the biocide composition contains N-butyl-1,2-benzisothiazolin-3-one alone as one component. In one particularly preferred embodiment of the invention the biocide composition comprises as one component either 1,2-benzisothiazolin-3-one alone or N-methyl-1,2-benzisothiazolin-3-one alone or a mixture of the two. In the last-mentioned case the weight ratio of 1,2-benzisothiazolin-3-one to N-methyl-1,2-benzisothiazolin-3-one is situated typically in the range (10-1):(1-10), preferably in the range of (4-1):(1-4), more preferably 1:1, with great advantage also being possessed by products which comprise 1,2-benzisothiazolin-3-one and N-methyl-1,2-benzisothiazolin-3-one in a weight ratio of 2:1 or 1:2.

The abovementioned benzisothiazolinone component can also be used together with a further organic biocide from the group of the isothiazolinones, as for example with octylisothiazolinone (OIT). Preferably the further biocide is halogen-free, more particularly free from CMIT.

An essential feature of the second component of the biocide composition of the invention is the presence of silver. The silver in this second component in the biocide composition is in a finely divided form, as elemental silver (Ag⁰), and/or in the form of soluble or insoluble silver compounds and/or as silver ions (Ag⁺). Depending on whether the biocide composition of the invention is in liquid or solid form, and depending on the form in which the silver is present within it, the silver in the biocide composition may be distributed homogeneously, in solution or solid mixture, for example, or in colloidal distribution, such as in colloidally disperse or nanoparticulate form, for example.

In one particular embodiment the silver is used in the form of organic or inorganic silver salts, as colloidal or nanoparticulate silver or as silver oxide.

In another embodiment of the present invention the silver, together with the 3-benzisothiazolinone, forms a single component (e.g., use of the silver salt of BIT).

In this case the combination component may come about when the components of the preparation are combined, or alternatively it may be present as one component from the start. This embodiment is particularly suitable for application in connection with film preservation.

Preferred biocide compositions of the invention comprise the silver in elemental form (Ag⁰), the silver having particle sizes of 0.1-100 μm, preferably from 0.2 to 80 μm, and more particularly from 0.25 to 60 μm. In one particularly preferred embodiment the silver used is nanosilver, even more finely divided silver having particle sizes from 0.001 to 0.1 μm, preferably from 0.002 to 0.05 μm, and more particularly from 0.004 to 0.01 μm.

The silver may alternatively be present in the form of silver compounds in the biocide compositions of the invention. Suitable such silver compounds include more particularly silver oxide and organic and/or inorganic silver salts, such as silver nitrate, silver acetate, silver benzoate, silver citrate, silver lactate or silver hexamethylenetetramine, for instance. Where light-sensitive and discoloration-sensitive silver compounds, examples being silver halides, such as silver chloride or silver bromide, are to be employed as a silver component in the biocide compositions of the invention, they are advantageously used in a specific, stabilized preparation. For example, light-sensitive and discoloration-sensitive silver compounds can be encapsulated so that they are protected from light radiation, with the encapsulation nevertheless at the same time being permeable for the microbiocidal silver ions. In this way silver chloride can be used in a stabilized preparation on titanium dioxide carrier material, for example. Light-stable silver compounds can also be used directly.

Silver with low particle sizes can be employed advantageously as a component in the biocide compositions of the invention by applying the silver to, or imbedding it in, carrier materials. For this purpose it is possible for suitable carrier materials to be, for example, impregnated with colloidal silver solutions or mixed with finely divided silver and/or silver compounds. It is of course also possible to granulate the silver together with the carrier materials, with addition of suitable granulating assistants. Suitable carrier materials include more particularly builders, examples being zeolites. In addition to these it is also possible for highly porous substances, such as silicas, fumed silicas, for example, bentonites, polymeric materials or diatomaceous earth (“kieselguhr”) to serve as carrier materials, and, furthermore, ceramic materials capable of ion exchange, and based for example on zirconium phosphate, or else glasses, especially bioactive or biocidal glasses. Silver fixed to carrier materials is already available commercially, examples being AlphaSan® (manufacturer: Milliken) or else AgION® (manufacturer: AgION Technologies).

It may be advantageous to use, in the biocide composition of the invention, in addition to the silver, further noble metals, such as gold and/or palladium, for example, which even in trace amounts (e.g., <0.01 ppm) activate the antimicrobial activity of the silver.

The biocide composition of the invention comprises the silver component (or silver compounds) preferably in specific amounts, not only absolutely but also relative to the isothiazolin-3-one component. In this context, for the purposes of the present invention, the basis used for calculation is always the amount of silver (Ag⁰). Where, for example, a product of the invention contains 100 mg of silver chloride per kg, its silver content is 73.53 mg per kg, expressed in % by weight as 0.007% by weight.

It is advantageous if the silver components and the benzisothiazolinone component in the biocide composition of the invention are present in a weight ratio of 1:1 to 100, preferably 1:1 to 50, more particularly of 1:1 to 25.

The biocide composition of the invention may be present and employed in different preparations, such as, for example, in solid form as a mixture of the components it contains.

It is advantageous for the biocide preparation of the invention to contain silver (Ag⁰) in an amount of 0.01% to 50%, preferably 0.1% to 25%, more preferably 0.5% to 10%, with particular preference 1.0% to 5.0% by weight. The amount of 3-isothiazolin-3-one component in the biocide preparation of the invention is preferably 0.1% to 50%, more preferably 0.25% to 25%, with particular preference 0.5% to 20%, with especial preference 0.75% to 15% by weight.

In one advantageous embodiment the biocidal composition of the invention is present in the form of a liquid preparation: for example, as a solution, suspension or dispersion in a liquid medium. It is of course also possible for the biocide preparation of the invention to be mixed directly in the product that is to be preserved.

If, in one advantageous embodiment, the biocide preparation of the invention is employed as a liquid preparation, the liquid medium used may be a polar and/or apolar medium. Preferred polar liquid media are water, aliphatic alcohols having 1 to 4 carbon atoms, such as ethanol and isopropanol, a glycol, such as ethylene glycol, diethylene glycol, 1,2-propylene glycol, dipropylene glycol, and tripropylene glycol, a glycol ether, such as butyl glycol and butyl diglycol, a glycol ester, such as butyl diglycol acetate or 2,2,4-trimethylpentanediol monoisobutyrate, a polyethylene glycol, a polypropylene glycol, N,N-dimethylformamide or a mixture of two or more such media. More particularly the polar liquid medium is water.

Examples of possible apolar liquid media include aromatics, preferably xylene and toluene. These as well can be used alone or as a mixture of two or more such media.

The biocide composition of the invention may also be combined simultaneously with a polar liquid medium and with an apolar liquid medium.

A further possibility is to adapt the biocide composition of the invention to specific objectives through the addition of further actives; for example, to adapt it for increased biocidal activity, or for improved compatibility with the substances to be protected from the microorganisms.

Specific examples of such further biocidal actives are given below:
benzyl alcohol
2,4-dichlorobenzyl alcohol
2-phenoxyethanol
2-phenoxyethanol hemiformal
phenylethyl alcohol
5-bromo-5-nitro-1,3-dioxane
formaldehyde and formaldehyde-releasing compounds
dimethyloldimethylhydantoin
glycoxal
glutaraldehyde
sorbic acid
benzoic acid
salicylic acid
p-hydroxybenzoic esters
chloroacetamide
N-methylolchloroacetamide
phenols, such as p-chloro-m-cresol and o-phenylphenol
N-methylolurea
N,N′-dimethylolurea
benzyl formal
4,4-dimethyl-1,3-oxazolidine
1,3,5-hexahydrotriazine derivatives
quaternary ammonium compounds, such as
   N-alkyl-N,N-dimethylbenzylammonium chloride and
   di-n-decyldimethylammonium chloride
cetylpyridinium chloride
diguanidine
polybiguanide
chlorhexidine
1,2-dibromo-2,4-dicyanobutane
3,5-dichloro-4-hydroxybenzaldehyde
ethylene glycol hemiformal
tetra(hydroxymethyl)phosphonium salts
dichlorophene
2,2-dibromo-3-nitrilopropionamide
3-iodo-2-propynyl N-butylcarbamate
methyl N-benzimidazol-2-ylcarbamate
N,N-dimethyl-2,2′-dithiodibenzamide
2-thiocyanomethylthiobenzothiazole
C-formals, such as
   2-hydroxymethyl-2-nitro-1,3-propanediol
   2-bromo-2-nitropropane-1,3-diol
methylenebisthiocyanate
reaction products of allantoin

Preferred such further biocidal actives are 3-iodo-2-propynyl N-butylcarbamate, formaldehyde or a formaldehyde-releasing compound, and 2-bromo-2-nitropropane-1,3-diol.

Examples of the formaldehyde-releasing compound are N-formals, such as
tetramethylolacetylenediurea
   N,N′-dimethylolurea
   N-methylolurea
   dimethyloldimethylhydantoin
   N-methylolchloroacetamide
   reaction products of allantoin
glycol formals, such as
   ethylene glycol formal
   butyl diglycol formal
benzyl formal

The biocide composition of the invention may further comprise other typical constituents as well that are known as additives in the field of biocides to the skilled person. These are, for example, thickeners, defoamers, pH modifiers, fragrances, dispersing assistants and coloring compounds or discoloration preventatives, complexing agents, and stabilizers.

The benzisothiazolinones used in accordance with the invention are known compounds and as such are obtainable commercially or can be prepared by known methods.

The biocide composition of the invention can be used for preservation across a very wide variety of fields. It is suitable, for example, for use in paint and coating materials, such as paints, varnishes, stains, and plasters, for example, in emulsions, latices, polymer dispersions, lignosulfonates, chalk slurries, mineral slurries, ceramic masses, adhesives, sealants, products containing casein, products containing starch, bitumen emulsions, surfactant solutions, motor fuels, cleaning products, pigment pastes and pigment dispersions, inks, lithographic fluids, thickeners, cosmetic products, toiletries, water circuits, liquids associated with paper processing, liquids associated with leather production, liquids associated with textile production, drilling and cutting oils, hydraulic fluids, cooling lubricants, and polymer coatings for—for example—floors, laminates, furniture parts, veneers, and varnishes, to counter infestation by—for example—bacteria, filamentous fungi, yeasts, and algae.

The biocide composition is suitable more particularly for use in paint and coating materials such as, for example, varnishes, adhesives, and paints, more particularly for interior applications such as for addition, for example, to interior emulsion paints.

With preference the biocidal composition of the invention is used to counter infestation by microorganisms in paint and/or coating materials, such as paints, varnishes, stains, and renders, in emulsions, latices, polymer dispersions, adhesives, cleaning products, mineral slurries, ceramic masses, pigment pastes and pigment dispersions, and sealants. Particularly preferred fields of use are paint and coating materials such as, for example, paints, varnishes, stains, and plasters, and also emulsions, latices, polymer dispersions, and adhesives.

The invention likewise relates to a process for producing a biocidal composition which involves combining the abovementioned components with the appropriate auxiliaries (such as solvents, for example).

The invention is also directed to a process for producing paint and coating materials that involves admixing commercially customary paint and coating materials with the abovementioned biocidal preparation. The components are then preferably intimately mixed.

In terms of practical application the biocidal composition can be incorporated, either as a finished mixture or by separate addition of the biocides and the other components of the composition, into the substance that is to be preserved.

In the substance to be preserved from infestation by microorganisms using the biocidal composition of the invention, the silver is present preferably in an amount of 0.1 ppm to 100 ppm, more preferably in an amount of 0.1 ppm to 50 ppm, with further preference in an amount of 0.1 ppm to 25 ppm, with particular preference in an amount of 0.1 ppm to 10 ppm, and with more particular preference in an amount of 0.1 ppm to 5 ppm. The amount of the benzisothiazolinone or benzisothiazolinones in the substance for preservation is preferably 0.0001% to 0.1%, more preferably 0.001% to 0.05%, with further preference 0.002% to 0.03%, with particular preference 0.003% to 0.02%, and with more particular preference 0.005% to 0.0150% by weight.

The biocidal compositions are suitable more particularly for controlling Candida albicans, Staphylococcus aureus, and Escherichia coli.

The examples below illustrate the invention.

### EXAMPLE 1

Investigation of the activity of a biocide composition comprising an isothiazolinone/silver combination (measured in accordance with ASTM E 2180-standard)

The activity of different combinations of silver and isothiazolinones (containing 5 ppm of silver ions combined with 50 ppm each of methyl-/benz-/N-methylbenz-/N-butylbenz-/octyl-isothiazolinone or 15 ppm of chloromethyl-/methyl-isothiazolinone (3:1)) was tested in a commercially customary paint film admixed with the biocidal mixture.

The biocide formulations comprise the following solutions:

MIT from Acticide® M 10 (10% strength aqueous MIT solution);
BIT from Acticide® BW 10 (10% strength aqueous BIT dispersion);
OIT from Acticide® OTW 8 (8% strength aqueous OIT emulsion);
CIT/MIT (3:1) from Acticide® MV (1.5% strength aqueous CIT/MIT solution);
N-methyl-BIT (preparable according to patent U.S. Pat. No. 3,761,489) from a 5% strength stock solution in dipropylene glycol;
N-butyl-BIT from Vanquish® 100 (manufacturer: Avecia); a 5% strength stock solution in dipropylene glycol is used;
silver from silver chloride on titanium dioxide carrier (2 percent silver chloride on titanium dioxide, product IMAC LP 10 (manufacturer: Clariant, Germany)).

The biocidal formulations were diluted accordingly in order to give the respective use concentrations of the individual actives in the paint film.

The concentration of CIT/MIT (3:1) was limited to 15 ppm.

The paint used was a standard interior emulsion paint, its formula as follows:

| Ingredient | Percentage fraction |
|---|---|
| water | 17.95 |
| Calgon N neu (water softener) | 0.05 |
| Dispex N 40 (dispersant) | 0.3 |
| Agitan 315 (defoamer) | 0.2 |
| CA 24 (filler) | 0.2 |
| TiO2 pigment (titanium dioxide) | 22 |
| talc 5/0 (filler) | 7 |
| Socal P 2 (filler) | 2 |
| Omyacarb 2-GU (calcite) | 11.80 |
| Omyacarb 5-GU (calcite) | 15.50 |
| Celite 281 SS (filler) | 2 |
| Tylose paste 3% (thickener) | 10 |
| Mowilith LDM 1871 (binder) | 11 |

The experiments were conducted along the lines of a standard test method for the investigation of antimicrobial activities (ASTM E 2180). For that purpose the isothiazolinone/silver components were incorporated into the abovementioned paint, stirred in well and then applied to glass supports (dimensions 4.5×4.5 cm). The test specimens thus obtained were stored at a temperature of 40° C. for three days so as to give a uniform, dry paint film.

The dry paint film was overlaid with an agar slurry containing the respective test organism, the microbe count of the batch being 1×10⁶ CFU/ml (colony-forming units per ml). The inoculated test specimens were incubated in a humid atmosphere at room temperature for 24 hours, and then the surviving cells were determined by means of serial dilution in an agar slurry.

The template microbes used for the study were the following three organisms: Staphylococcus aureus ATCC 6538, E. coli ATCC 8739, Candida albicans ATCC 10259.

For this purpose the diluted slurry eluates were plated out onto selective nutrients and stored for 48 hours at 30° C. (bacteria) or for 72 hours at 25° C. (yeasts) in corresponding incubators. As a comparison, use was made in each case of the unpreserved aforementioned paint (blank) and an uninoculated sterile control (control).

A surprising strong activity was achieved by the combinations (c) BIT/silver and (f) N-methyl-BIT/silver, which led to a significant reduction in microbe count against all three of the test microbes.

All of the other combinations exhibited only a limited activity in the paint.

The samples (a), without preservation (blank), and (b), MIT/silver, gave unsatisfactory activity, whereas the samples (d), CIT/MIT (3:1)/silver, (e) OIT/silver, and (g), butyl-BIT/silver, likewise exhibited activity against Candida albicans but proved not to be active against the two other bacterial strains tested.

TABLE 1

| | | | Evaluation after 24 h | |
|---|---|---|---|---|
| | | Candida | Staph. | E. coli |
| | | albicans | aureus | microbes/ |
| Sample designation | | microbes/ml | microbes/ml | ml |
| blank | a | >10⁶ | >10⁶ | >10⁶ |
| 50 ppm MIT + 5 ppm Ag⁺ | b | >10⁶ | >10⁶ | >10⁶ |
| 50 ppm BIT + 5 ppm Ag⁺ | c | 8 × 10³ | 1.4 × 10⁴ | 7.6 × 10³ |
| 15 ppm MIT/CIT + | d | 3.6 × 10⁵ | >10⁶ | >10⁶ |
| 5 ppm Ag⁺ | | | | |
| 50 ppm OIT + 5 ppm Ag⁺ | e | 3.6 × 10³ | >10⁶ | >10⁶ |
| 50 ppm, N-methyl-BIT + | f | 2.3 × 10³ | 3.3 × 10⁴ | 8.8 × 10³ |
| 5 ppm Ag⁺ | | | | |
| 50 ppm, N-butyl-BIT + | g | 4 × 10³ | >10⁶ | >10⁶ |
| 5 ppm Ag⁺ | | | | |
| control | | <10 | <10 | <10 |

### EXAMPLE 2 INVESTIGATION OF THE SYNERGISTIC EFFECT

The synergism of a combination of silver with 1,2-benzisothiazolin-3-one (BIT) was tested. Silver was used in the form of silver nitrate. When, for example, 30 ppm of silver nitrate are used, the amount of silver is 19.1 ppm. The test organism used was the gram-negative bacterium Pseudomonas aeruginosa (ATCC 9027). For the test, aqueous mixtures with different concentrations of silver nitrate and BIT were prepared and were tested for their activity on Pseudomonas aeruginosa. The aqueous mixtures further included a Müller-Hinton broth (commercial product “Merck Nr. 10393”) as nutrient medium. The cell density of Pseudomonas aeruginosa was 10⁶ microbes/ml.

The incubation time was 72 h at 25° C. Each sample was incubated at 120 rpm on an incubation shaker. After 72 h the samples were inspected for growth of Pseudomonas aeruginosa. Growth was shown through a clouding of the nutrient medium. In this way, the minimum inhibitory concentrations (MICs) of the two actives, individually and in combination, were ascertained. The MIC is the concentration at which there is no longer any clouding of the nutrient medium.

The synergism arising was represented numerically by calculation of the synergy index (SI). The calculation was made in accordance with the commonplace method of F. C. Kull et al., Applied Microbiology, vol. 9 (1961), p. 538. There the SI is calculated according to the following formula:

synergy index SI=Qₐ/Q_{A}+Q_{b}/Q_{B}.

When this formula is applied to the biocide system BIT+Ag under test here, the parameters in the formula are defined as follows:
Qₐ=concentration of BIT in the biocide mixture of BIT+Ag
QA=concentration of BIT as a single biocide
Q_{b}=concentration of Ag in the biocide mixture of BIT+Ag
Q_{B}=concentration of Ag as a single biocide

If the synergy index has a value of more than 1, this means that antagonism is present. If the synergy index adopts a value of 1, this means that the two biocides have an additive effect. If the synergy index adopts a value of below 1, this means that the two biocides exhibit synergism.

Table 2 shows the minimum inhibitory concentrations found and also the synergy indices calculated for the combination of silver and BIT in the case of Pseudomonas aeruginosa (ATCC 9027).

TABLE 2
Calculation of the synergy index of BIT + Ag for Pseudomonas aeruginosa
with an incubation time of 72 h/25° C.

| MIC at | | | Concentration | | | | |
|---|---|---|---|---|---|---|---|
| BIT | Ag | Total concentration | BIT | Ag | | | Synergy |
| concentration | concentration | BIT + Ag | (% | (% | | | index |
| Qₐ | Q_{b} | Qₐ + Q_{b} | by | by | | | Qₐ/Q_{A} + Q_{b}/ |
| (ppm) | (ppm) | (ppm) | weight) | weight) | Qₐ/Q_{A} | Q_{b}/Q_{B} | Q_{B} |
| 0 | 25.4 | 25.4 | 0.0 | 100.0 | 0.00 | 1.00 | 1.00 |
| 5 | 19.1 | 24.1 | 20.7 | 79.3 | 0.13 | 0.75 | 0.88 |
| 20 | 9.5 | 29.5 | 67.8 | 32.2 | 0.50 | 0.38 | 0.88 |
| 20 | 6.4 | 26.4 | 75.8 | 24.2 | 0.50 | 0.25 | 0.75 |
| 20 | 4.8 | 24.8 | 80.6 | 19.4 | 0.50 | 0.19 | 0.69 |
| 20 | 3.2 | 23.2 | 86.2 | 13.8 | 0.50 | 0.13 | 0.63 |
| 30 | 0.6 | 30.6 | 98.0 | 2.0 | 0.75 | 0.03 | 0.78 |
| 30 | 0.3 | 30.3 | 99.0 | 1.0 | 0.75 | 0.01 | 0.76 |
| 30 | 0.2 | 30.2 | 99.3 | 0.7 | 0.75 | 0.01 | 0.76 |
| 40 | 0 | 40 | 100.0 | 0.0 | 1.00 | 0.00 | 1.00 |

Qₐ = BIT concentration (mixture of BIT + Ag) which shows an endpoint
Q_{A} = BIT concentration (BIT alone) which shows an endpoint
Q_{b} = Ag concentration (mixture of BIT + Ag) which shows an endpoint
Q_{B} = Ag concentration (Ag alone) which shows an endpoint

From table 2 it is evident that the optimum synergism, i.e., the lowest synergy index (0.63) of a BIT+Ag mixture, is situated at a ratio of 86.3% by weight of BIT to 13.7% by weight of Ag.

### EXAMPLE 3 INVESTIGATION OF THE SYNERGISTIC EFFECT

The experiment from example 2 was repeated in the same way but using the gram-positive test organism Staphylococcus aureus (ATCC 6538) instead of Pseudomonas aeruginosa. Table 3 shows the minimum inhibitory concentrations found and the synergy indices calculated for the system tested.

TABLE 3
Calculation of the synergy index of BIT + Ag for Staphylococcus aureus
with an incubation time of 72 h/25° C.

| MIC at | | | Concentration | | | | |
|---|---|---|---|---|---|---|---|
| BIT | Ag | Total concentration | BIT | | | | Synergy |
| concentration | concentration | BIT + Ag | (% | Ag | | | index |
| Qₐ | Q_{b} | Qₐ + Q_{b} | by | (% by | | | Qₐ/Q_{A} + Q_{b}/ |
| (ppm) | (ppm) | (ppm) | weight) | weight) | Qₐ/Q_{A} | Q_{b}/Q_{B} | Q_{B} |
| 0 | 19.1 | 19.1 | 0.0 | 100.0 | 0.00 | 1.00 | 1.00 |
| 5 | 12.7 | 17.7 | 28.2 | 71.8 | 0.25 | 0.66 | 0.91 |
| 5 | 9.5 | 14.5 | 34.5 | 65.5 | 0.25 | 0.50 | 0.75 |
| 5 | 6.4 | 11.4 | 43.9 | 56.1 | 0.25 | 0.34 | 0.59 |
| 5 | 4.8 | 9.8 | 51.0 | 49.0 | 0.25 | 0.25 | 0.50 |
| 5 | 3.2 | 8.2 | 61.0 | 39.0 | 0.25 | 0.17 | 0.42 |
| 10 | 1.9 | 11.9 | 84.0 | 16.0 | 0.50 | 0.10 | 0.60 |
| 10 | 0.6 | 10.6 | 94.3 | 5.7 | 0.50 | 0.03 | 0.53 |
| 10 | 0.3 | 10.3 | 97.1 | 2.9 | 0.50 | 0.02 | 0.52 |
| 20 | 0 | 20 | 100.0 | 0.0 | 1.00 | 0.00 | 1.00 |

Qₐ = BIT concentration (mixture of BIT + Ag) which shows an endpoint
Q_{A} = BIT concentration (BIT alone) which shows an endpoint
Q_{b} = Ag concentration (mixture of BIT + Ag) which shows an endpoint
Q_{B} = Ag concentration (Ag alone) which shows an endpoint

From table 3 it is evident that the optimum synergism, i.e., the lowest synergy index (0.42) of a BIT+Ag mixture is situated at a ratio of 61.0% by weight of BIT to 39.0% by weight of Ag.

### EXAMPLE 4 EXPERIMENT ON SYNERGISM WITH MBIT

Example 3 was repeated in the same way, but with N-methyl-1,2-benzisothiazolin-3-one (MBIT) as the biocidal component.

TABLE 4
Calculation of the synergy index for Staphylococcus aureus
with an incubation time of 96 h/25° C.

| MIC at | | | Concentration | | | | |
|---|---|---|---|---|---|---|---|
| MBIT | Ag | Total concentration | MBIT | | | | Synergy |
| concentration | concentration | MBIT + Ag | (% | Ag | | | index |
| Qₐ | Q_{b} | Qₐ + Q_{b} | by | (% by | | | Qₐ/Q_{A} + Q_{b}/ |
| (ppm) | (ppm) | (ppm) | weight) | weight) | Qₐ/Q_{A} | Q_{b}/Q_{B} | Q_{B} |
| 0 | 27 | 25.4 | 0.0 | 100.0 | 0.00 | 1.00 | 1.00 |
| 10 | 9.5 | 19.5 | 51.3 | 48.7 | 0.50 | 0.37 | 0.87 |
| 10 | 6.4 | 16.4 | 61.0 | 39.0 | 0.50 | 0.25 | 0.75 |
| 10 | 4.8 | 14.8 | 67.6 | 32.4 | 0.50 | 0.19 | 0.69 |
| 20 | 0 | 20 | 100.0 | 0.0 | 1.00 | 0.00 | 1.00 |

Qₐ = MBIT concentration (mixture of MBIT + Ag) which shows an endpoint
Q_{A} = MBIT concentration (MBIT alone) which shows an endpoint
Q_{b} = Ag concentration (mixture of MBIT + Ag) which shows an endpoint
Q_{B} = Ag concentration (Ag alone) which shows an endpoint

From table 4 it is evident that the optimum synergism, i.e., the lowest synergy index (0.69) of a MBIT+Ag mixture, is situated at a ratio of 67.6% by weight of MBIT to 32.4% by weight of Ag.

### EXAMPLE 5 EXPERIMENT ON SYNERGISM WITH N-butyl-BIT

Example 3 was repeated, but using N-butyl-1,2-benzisothiazolin-3-one (BBIT) as the biocidal component.

TABLE 5
Calculation of the synergy index for Staphylococcus aureus
with an incubation time of 96 h/25° C.

| MIC at | | | Concentration | | | | |
|---|---|---|---|---|---|---|---|
| BBIT | Ag | Total concentration | BBIT | | | | Synergy |
| concentration | concentration | BBIT + Ag | (% | Ag | | | index |
| Qₐ | Q_{b} | Qₐ + Q_{b} | by | (% by | | | Qₐ/Q_{A} + Q_{b}/ |
| (ppm) | (ppm) | (ppm) | weight) | weight) | Qₐ/Q_{A} | Q_{b}/Q_{B} | Q_{B} |
| 0 | 25.4 | 25.4 | 0.0 | 100.0 | 0.00 | 1.00 | 1.00 |
| 10 | 9.5 | 19.5 | 51.3 | 48.7 | 0.50 | 0.37 | 0.87 |
| 10 | 6.4 | 16.4 | 61.0 | 39.0 | 0.50 | 0.25 | 0.75 |
| 10 | 4.8 | 14.8 | 67.6 | 32.4 | 0.50 | 0.19 | 0.69 |
| 10 | 3.2 | 13.2 | 75.8 | 24.2 | 0.50 | 0.13 | 0.63 |
| 10 | 1.9 | 11.9 | 84.0 | 16.0 | 0.50 | 0.07 | 0.57 |
| 20 | 0 | 20 | 100.0 | 0.0 | 1.00 | 0.00 | 1.00 |

Qₐ = BBIT concentration (mixture of BBIT + Ag) which shows an endpoint
Q_{A} = BBIT concentration (BBIT alone) which shows an endpoint
Q_{b} = Ag concentration (mixture of BBIT + Ag) which shows an endpoint
Q_{B} = Ag concentration (Ag alone) which shows an endpoint

From table 5 it is evident that the optimum synergism, i.e., the lowest synergy index (0.57) of a BBIT+Ag mixture, is situated at a ratio of 84.0% by weight of BBIT to 16.0% by weight of Ag.

1-22. (canceled)

23. A biocidal composition comprising a combination of at least two biocidal components, comprising as a first component 0.001% to 0.05% by weight of at least one compound selected from the group consisting of 1,2-benzisothiazolin-3-one, N-methyl-1,2-benzisothiazolin-3-one, and N-butyl-1,2-benzisothiazolin-3-one, and comprising as a second component 0.1 ppm to 25 ppm of silver in the form of elemental silver and/or organic or inorganic silver compounds, and the weight ratio of silver component to benzisothiazolinone component being from 1:1 to 1:100.

24. The biocidal composition as claimed in claim 23, wherein the silver is present in the form of organic or inorganic silver salts or as colloidal or nanoparticulate silver.

25. The biocidal composition as claimed in claim 23, wherein the silver is imbedded in an organic or inorganic carrier material.

26. The biocidal composition as claimed in claim 25, wherein the silver is present in a glass, a zeolite or ion-exchange resin in releasable form.

27. The biocidal composition as claimed in claim 25, wherein the silver component is composed of silver chloride on a titanium dioxide carrier.

28. The biocidal composition as claimed in claim 23, wherein the silver component and the benzisothiazolinone component are present in a weight ratio of 1:1 to 50.

29. The biocidal composition as claimed in claim 28, wherein the silver component and the benzisothiazolinone component are present in a weight ratio of 1:1 to 25.

30. The biocidal composition as claimed in claim 23, wherein the compound 1,2-benzisothiazolin-3-one is used as benzisothiazolinone component and wherein the further biocide as well is halogen-free.

31. The biocidal composition as claimed in claim 30, wherein the 1,2-benzisothiazolin-3-one is used as a biocidal component in a synergistic combination with the silver component.

32. The biocidal composition as claimed in claim 31, wherein N-methyl-1,2-benzisothiazolin-3-one is used as a biocidal component.

33. The biocidal composition as claimed in claim 30, wherein a mixture of N-methyl-1,2-benzisothiazolin-3-one and 1,2-benzisothiazolin-3-one in a weight ratio of (10-1):(1-10) is used as a biocidal component.

34. The biocidal composition as claimed in claim 23, wherein at least one of the compounds octylisothiazolinone (OIT), N-methyl-benzisothiazolinone (N-methyl-BIT) or N-butyl-benzisothiazolinone (N-butyl-BIT) is used as a further biocidal component.

35. The biocidal composition as claimed in claim 23, in the form of a liquid preparation.

36. The biocidal composition as claimed in claims 23, comprising a further noble metal in addition to silver.

37. The use of the biocidal composition as claimed in claim 23, for in-can preservation or for film preservation.

38. The use of the biocidal composition as claimed in claim 23, for the preservation of coating and paint materials.

39. A product selected from paint and coating materials, emulsions, latices, polymer dispersions, lignosulfonates, chalk slurries, mineral slurries, ceramic masses, adhesives, sealants, products containing casein, products containing starch, bitumen emulsions, surfactant solutions, motor fuels, cleaning products, pigment pastes and pigment dispersions, inks, lithographic fluids, thickeners, cosmetic products, toiletries, water circuits, liquids associated with paper processing, liquids associated with leather production, liquids associated with textile production, drilling and cutting oils, hydraulic fluids and cooling lubricants, comprising a biocidal composition as claimed in claim 23.
